(19) United States
(12) Patent Application Publication
(10) Pub. No.: US 2005/0241346 A1
(43) Pub. Date: Nov. 3, 2005

(54) Driving unit of top loading drum type washing machine

(75) Inventor: Soung Bong Choi, Changwon-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/024,970

(22) Filed: Dec. 30, 2004

(30) Foreign Application Priority Data
Dec. 30, 2003 (KR) P2003-99877

(51) Int. Cl. D06F 37/30; B08B 3/12; H02K 1/04; H02K 1/12

(52) U.S. Cl. 68/140; 68/3 R; 68/12.24; 68/139; 310/67 R; 310/43; 310/254; 310/90; 310/217; 310/216; 310/259; 68/24; 68/58

(57) ABSTRACT

Disclosed is a top loading drum type washing machine with an improved structure of an operating member, the improved structure enabling to enhance a manufacturing process of parts of the operating member and to reduce noises and troubles, thereby increasing product reliability, the top loading drum type washing machine comprising a cabinet having a door at a side thereof, a tub provided in the cabinet and having a door at a location corresponding to the door of the cabinet, a drum rotatably supported by left and right sides of the tube and having a door for withdrawing laundries on an outer circumferential surface thereof, a shaft passed through the tub and pivotly coupled with the drum provided inside of the tub so as to transmit driving force of the motor to the drum, at least one bearing supporting the shaft, a bearing housing supporting the bearing and attached to the tub, a stator weighing over 1.5 kg, and a rotor covering an outer circumferential surface of the stator, wherein the stator comprises a stator core formed in a ring shape and including a multilayered structure in which a plurality of steel plates including a teeth and a base member are stacked and spirally rotated from a bottommost layer to a topmost layer, an insulator formed for covering an outside of the stator core via insert molding so as to electrically insulate the stator core, and at least three coupling members integrated into the insulator on an inner circumferential surface of the stator core, protruded toward the center of the stator and having a coupling hole formed in the center thereof so as to fix the stator on the bearing housing via a screw.

### CROSS-REFERENCE TO RELATED APPLICATIONS

This application claims the benefit of Korean Application No. P2003-99877, filed on Dec. 30, 2003, which is hereby incorporated by reference as if fully set forth herein.

### BACKGROUND OF THE INVENTION

1. Field of the Invention

The present invention relates to a top loading drum type washing machine, and more particularly, to a structure of an operating member of a top loading drum type washing machine, in which laundries are placed or withdrawn to/from the top of the washing machine and the operating member thereof is directly driven by a motor.

2. Discussion of the Related Art

In general, a drum washing method includes the steps of placing detergent, wash water, and laundries into a drum, receiving a driving force from a motor, and washing using friction between a rotating drum and the laundries. The drum washing method enables to prevent the laundries from being damaged and from being tangled with each other, and to achieve a rub washing effect.

In the mean time, the top loading washing machine is developed for making it easy to place or withdraw the laundries to/from the washing machine. Referring to FIGS. 1 to 3, the structure of the top loading drum washing machine will be briefly described as follows.

FIG. 1 is a front view showing an exterior of a top loading washing machine of a related art and FIG. 2 is a side view of FIG. 1, both views showing a door (D) provided at an upper part of a cabinet 1, a detergent box (DB) provided at a side of the door (D), and a control panel (CP) provided at a second side of the door (D).

FIG. 3 illustrates a front longitudinal section view of a main portion, showing an inner structure of the top loading drum washing machine of the related art. In the top loading drum washing machine, a tub 2 is hanged and supported by a spring in the cabinet 1, and a drum 3 is rotatably provided in the center of the inside of the tub 2. A bearing housing 7 for supporting bearings 6a and 6b is mounted on a central portion of a first side of the tub 2, and a first end of a drum axis 4 passing through the center of the bearing housing 7 is directly coupled with a rear portion of the drum.

A second end of the drum axis 4 is directly coupled with a motor 5. Meanwhile, a supporting axis 4a directly coupled with the second end of the drum 3 is installed on a second side of the tub 2 so as to be supported by a bearing 28.

In the top loading drum type washing machine, a tub opening 20b and a drum opening 23b are simultaneously opened via an operation of a coupling means (not shown) which links an opening/closing movement when the door (D) is opened.

The top loading drum type washing machine introducing a BLDC motor, however, has a problem as follows. Therefore, a direct-driven drum type washing machine with a new structure is demanded.

In other words, the top loading drum type washing machine of the related art has problems that manufacturing materials such as a core are wasted during the manufacture of a motor, that a process of manufacturing a motor is complex, and that it is difficult to effectively reduce vibrations or noises when the motor is disposed at the tub 2 owing to a weak stiffness.

Particularly, as for a monitor for the top loading drum washing machine with a large capacity, the motor having a stator fixed on the bearing housing 7 at a side of the tub and weighing at over 1.5 kg itself and enabling to rotate at a dehydration rotation speed of about 600-2,000 RPM, a coupling part of a stator 14 and the tub 2 is damaged because of the weight of the stator 14, vibration, and shakes and shape change of a rotor during the high speed rotation.

In other words, in the case of the top loading drum type washing machine using the BLDC motor and having the stator 14 coupled with a side of the tub 2, the stator 14 is coupled to a side of the tub 2 such that a surface of the stator 14 lies at right angles to a ground surface. Accordingly, a coupling part of the stator 14 is more heavily damaged.

To prevent this problem, when a conventional core 15a of the stator 14 is manufactured, a steel plate is pressed so as to make a teeth and a base member and, at the same time, to form a projection 500 for coupling on an opposite side of the teeth, and the substrate is stacked so as to form the core 15a in the form illustrated in FIG. 4 and used.

A method of manufacturing the sectional core 15a of the stator 14 is complex and waists materials so much.

In order to reduce waste of the materials and to make the manufacturing process simple, it is good to use a so-called helical core made by stacking up and spirally rotating a plurality of steel plates each including a teeth and a base member. [7] When the helical core is manufactured, a steel plate punched in a string form however needs to be bent, and thus it is difficult to provide a projection 500 for coupling the stator 15 with the bearing housing 7.

It is because when the projection 500 is formed, the core becomes too wide, and thus it is impossible to stack up and spirally wind up the core.

As for a structure in which the core is directly attached onto a wall of the tub 2, when the core is provided such that a surface of the stator lies at the right angles to the ground, and when the stator weighs over 1.5 kg, many problems are raised such as a damage generated on the tub side.

### SUMMARY OF THE INVENTION

Accordingly, the present invention is directed to a top loading drum washing machine that substantially obviates one or more problems due to limitations and disadvantages of the related art.

An object of the present invention is to provide a stator structure enabling to reduce materials and weight during the manufacture of a BLDC motor for a top loading drum washing machine, to simplify a manufacturing process thereof, and to stably mount the stator at a fixing side such as a bearing housing or a tub.

Another object of the present invention is to provide a structure enabling to easily assemble the stator in the process of assemblage.

Another object of the present invention is to provide a structure in which the tub is capable of sustaining the weight and vibration of the motor when the BLDC motor for a washing machine is attached directly on a wall of the tub made of a plastic material, the motor having a stator which weighs heavy and being rotatable at or more than a speed of about 2,000 RPM and controlling the rotation of the drum.

Another object of the present invention is to provide an operating structure making it easier for a worker to service for maintenance or repair.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a top loading drum type washing machine comprising a cabinet having a door at a side thereof, a tub provided in the cabinet and having a door at a location corresponding to the door of the cabinet, a drum rotatably supported by left and right sides of the tube and having a door for withdrawing laundries on an outer circumferential surface thereof, a shaft passed through the tub and pivotly coupled with the drum provided inside of the tub so as to transmit driving force of the motor to the drum, at least one bearing supporting the shaft, a bearing housing supporting the bearing and attached to the tub, a stator weighing over 1.5 kg, and a rotor covering an outer circumferential surface of the stator, wherein the stator comprises a stator core formed in a ring shape and including a multilayered structure in which a plurality of steel plates including a teeth and a base member are stacked and spirally rotated from a bottommost layer to a topmost layer, an insulator formed for covering an outside of the stator core via insert molding so as to electrically insulate the stator core, and a coupling member integrated into the insulator on an inner circumferential surface of the stator core, protruded toward the center of the stator and having a coupling hole formed in the center thereof so as to fix the stator on the bearing housing via a screw.

In another aspect of the present invention, a top loading drum type washing machine comprising a cabinet having a door at a side thereof, a tub provided in the cabinet and having a door at a location corresponding to the door of the cabinet, a drum rotatably supported by left and right sides of the tube and having a door for withdrawing laundries on an outer circumferential surface thereof, a shaft passed through the tub and pivotly coupled with the drum provided inside of the tub so as to transmit driving force of the motor to the drum, at least one bearing supporting the shaft, a bearing housing supporting the bearing and attached to the tub, a stator weighing over 1.5 kg, and a rotor covering an outer circumferential surface of the stator, wherein the stator comprises a stator core formed in a ring shape and including a multilayered structure in which a plurality of steel plates including a teeth and a base member are stacked and spirally rotated from a bottommost layer to a topmost layer, an insulator for inserting and molding insulating material on an outer surface of the stator core, and a coupling member integrated into the insulator on an inner circumferential surface of the stator core and protruded toward the center of the stator, wherein the coupling member comprising a coupling hole provided in the center of the coupling member so as to fix the stator via a coupling means on the bearing housing on a side of the tub, a position determining projection or position determining recess formed at the insulator of the stator, a projection or a recess corresponding to the position determining projection and the position determining recess and formed at the bearing housing, and a coupling hole formed at the bearing housing and corresponding to the coupling hole formed at the insulator of the stator.

In another aspect of the present invention, a top loading drum type washing machine comprising a cabinet having a door at a side thereof, a tub made of a plastic material, provided in the cabinet and having a door at a location corresponding to the door of the cabinet, a drum rotatably supported by left and right sides of the tube and having a door for withdrawing laundries on an outer circumferential surface thereof, a shaft passed through the tub and pivotly coupled with the drum provided inside of the tub so as to transmit driving force of the motor to the drum, at least one bearing supporting the shaft, a bearing housing for supporting the bearing and being fixed on the tub, a stator fixed on a rear side wall member of the tub, and a rotor covering an outer circumferential surface of the stator, wherein the stator comprises a stator core formed in a ring shape and including a multilayered structure in which a plurality of steel plates including a teeth and a base member are stacked and spirally rotated from a bottommost layer to a topmost layer, an insulator formed for covering an outside of the stator core via insert molding so as to electrically insulate the stator core, and a coupling member integrated into the insulator on an inner circumferential surface of the stator core, protruded toward the center of the stator and having a coupling hole formed in the center thereof so as to fix the stator on the bearing housing via a screw.

Meanwhile, an outer rotor type DC motor for a top loading drum type washing machine, wherein the top loading drum type washing machine comprises a stator core formed in a ring shape and including a multilayered structure in which a plurality of steel plates including a teeth and a base member are stacked and spirally rotated from a bottommost layer to a topmost layer, an insulator manufactured by inserting the stator core into a mold for forming the insulator and covering with an insulating material so as to insulate the stator core, a stator integrated into the insulator on an inner circumferential surface of the stator core and including at least three coupling member, the at least three coupling member protruded toward the center of the stator, and coil wound around the teeth of the stator core, and a rotor provided on an outside of the stator and having a cooling fin and a vent for cooling the stator.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a front view showing an exterior example of a top loading washing machine of a related art;

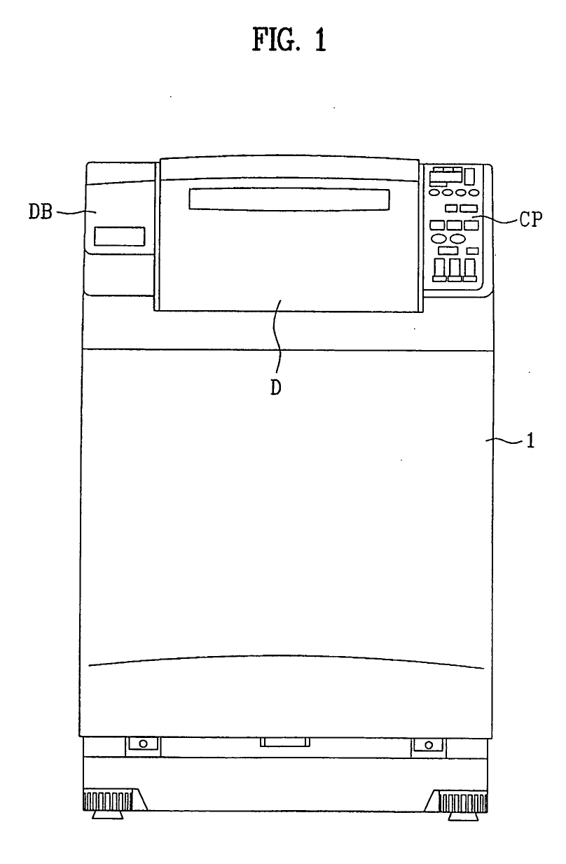

FIG. 2 illustrates a side view of FIG. 1;

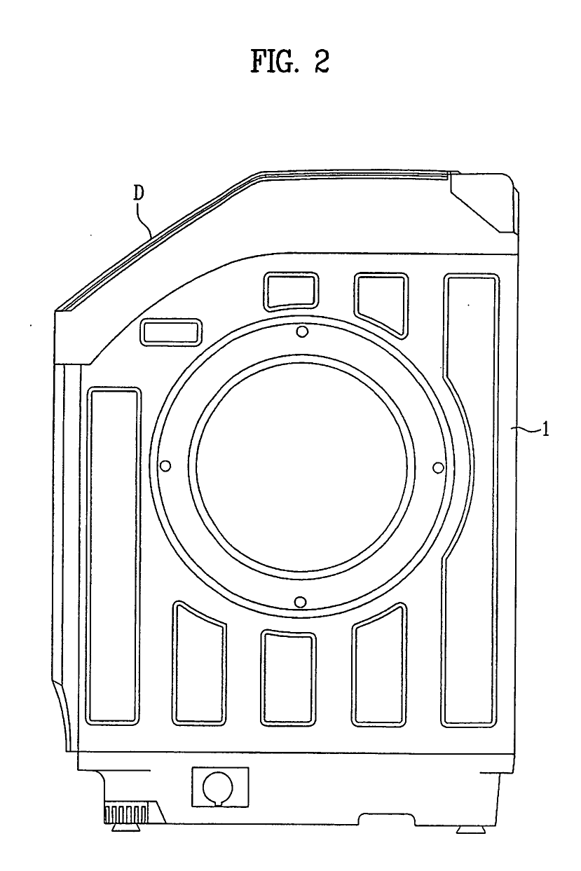

FIG. 3 illustrates a front longitudinal section view of a main portion, showing an inner structure of the top loading drum washing machine of the related art;

FIG. 4 illustrates a perspective view showing a sectional core of the related art, applied to a stator of FIG. 2;

FIG. 5 illustrates a perspective view showing a first embodiment of a stator of the present invention;

FIG. 6a and FIG. 6b illustrate an enlarged view showing a main portion of FIG. 5, wherein FIG. 6a illustrates a floor plan of the main portion and FIG. 6b illustrates a perspective view of the main portion;

FIG. 7 illustrates a perspective view showing a stator core applied to a stator of the present invention; and

FIG. 8 illustrates a detailed cross sectional view showing a structure of a driving unit of a drum washing machine to which the stator in accordance with the present invention is applied.

FIG. 9 illustrates a perspective view showing a second embodiment of the stator of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

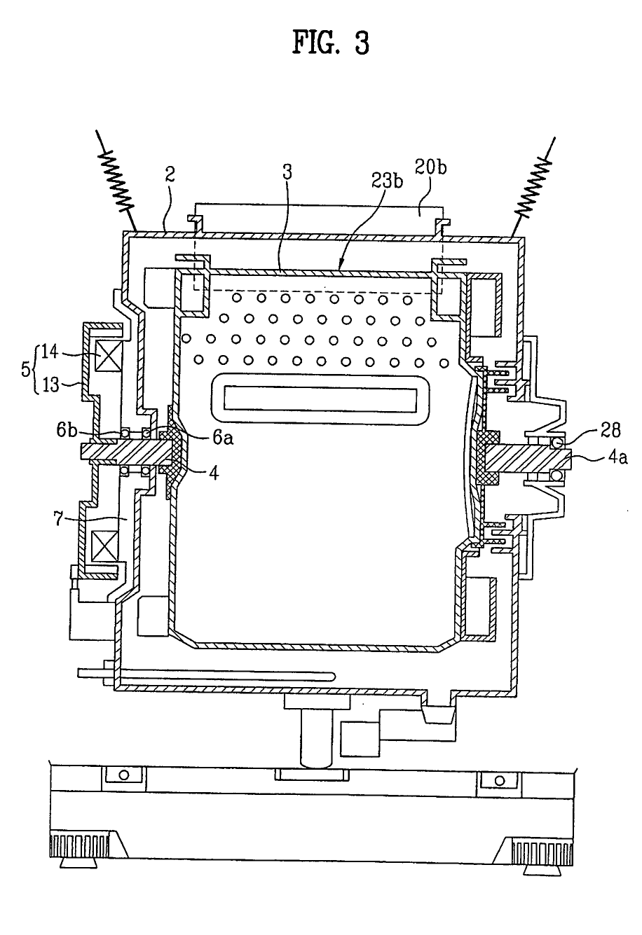

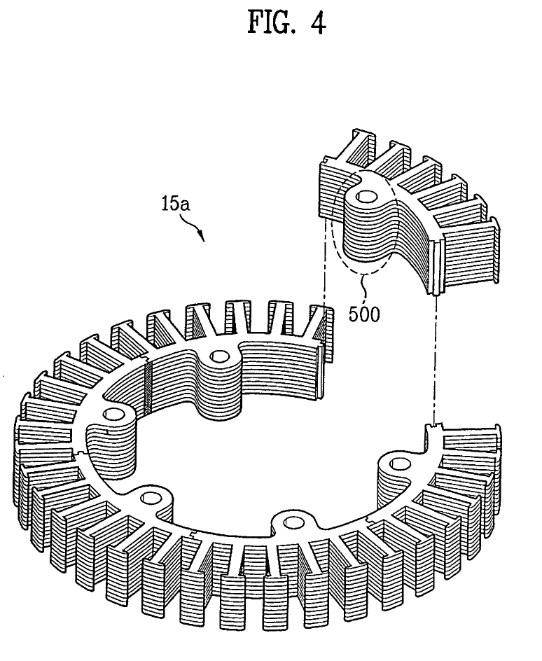

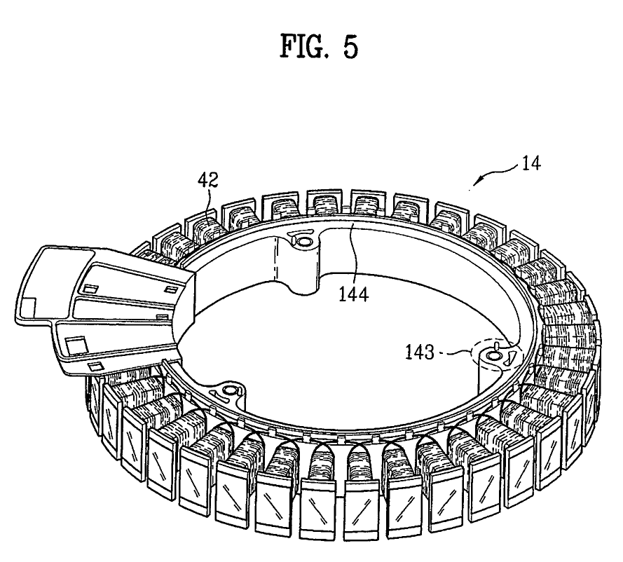

Referring to FIGS. 3 to 9, embodiments of the present invention will be described in detail. First of all, a first embodiment will be described referring to FIGS. 5 to 8.

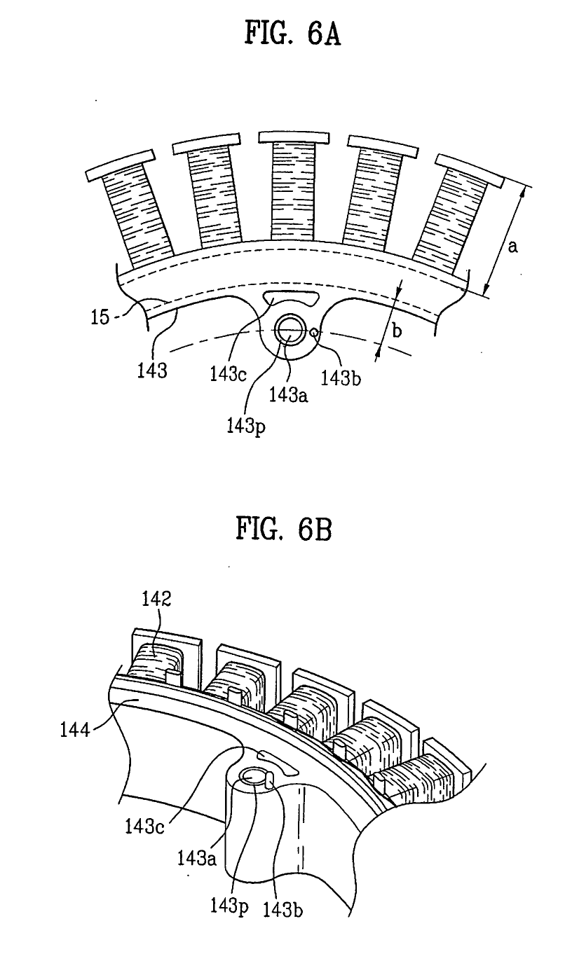

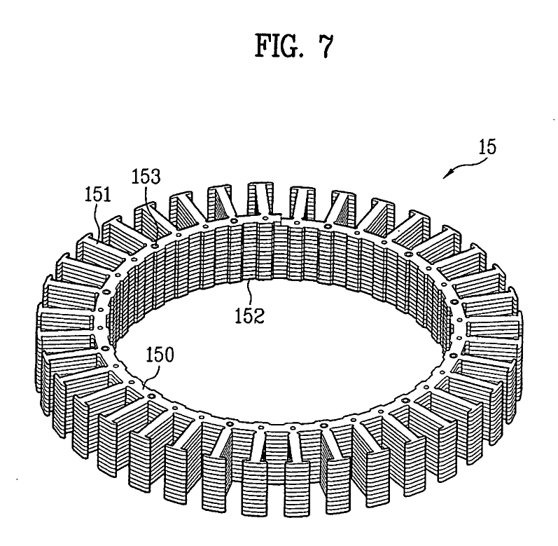

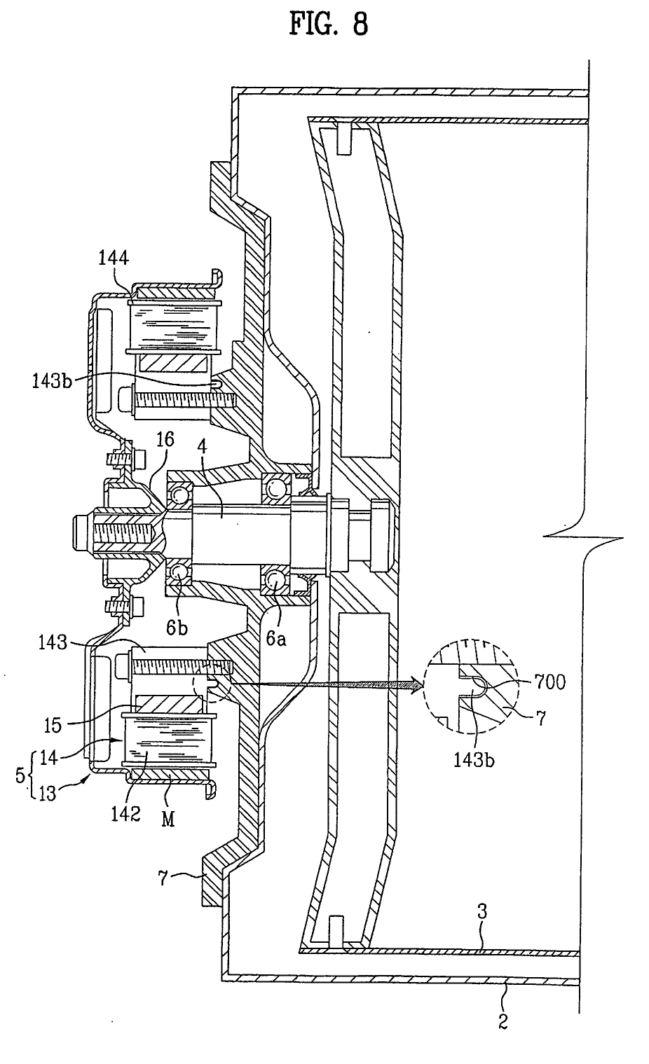

FIG. 5 illustrates a perspective view showing a first embodiment of a stator of the present invention, FIG. 6a and FIG. 6b illustrate an enlarged view showing a main portion of FIG. 5, FIG. 7 illustrates a perspective view showing a stator core applied to a stator of the present invention, and FIG. 8 illustrates a detailed cross sectional view showing a structure of a driving unit of a drum washing machine to which the stator in accordance with the present invention is applied.

A top loading drum type washing machine in accordance with the first embodiment of the present invention includes a cabinet having a door at a side thereof, a tub provided in the cabinet and having a door at a location corresponding to the door of the cabinet, a drum being rotatably supported by a left side of the tube and having a door for withdrawing the laundries on an outer circumferential surface thereof, a shaft 4 pivotly coupled with the drum 3 passed through the tub 2 and provided inside of the tub 2, at least one of bearings 6a and 6b supporting a side of the shaft 4, a bearing housing 7 attached to the tub, a stator 14 fixed on the bearing housing 7, and a rotor 13 covering an outer circumferential surface of the stator 14.

In this instance, the stator 14 includes a stator core 15 formed in a ring shape and including a multilayered structure in which a plurality of steel plates including a teeth 151 and a base member 150 are stacked and spirally rotated from a bottommost layer to a topmost layer, an insulator 144 formed to cover an outside of the stator core 15 via insert molding so as to electrically insulate the stator core 15, and at least three coupling members 143 integrated into the insulator 144 on an inner circumferential surface of the stator core 15 and protruded toward the center of the stator 14.

A coupling hole 143a is provided in the center of the coupling members 143 so as to screw down the stator 14 on the bearing housing 7 attached on a side of the tub.

A position determining projection 143b is provided at the insulator 144 of the stator 14, and a recess 700 (refer to FIG. 8) corresponding to the position determining projection 143b provided at the insulator 144 is provided at the bearing housing 7.

In this case, the recess for position determination may be provided at the insulator 144 of the stator 14, and a projection may be provided at the bearing housing 7.

The stator 14 further includes a cylindrical metal 143p inserted into the coupling hole 143a provided in the center of the coupling member 143. In this case, the cylindrical metal 143p may include a spring pin having an elasticity via an incised portion, or a hollow pin capable of being pressed and inserted into the coupling hole 143a.

In this case, height of the coupling member 143 is more than 20%, preferably 20%-150% of the total height of the stacked cores.

When a height of the teeth 151 protruded from the outside of the stator core 15 is “a” and a distance from an inside of the stator core 15 to the center of the coupling hole 143a provided at the coupling member 143 is “b”, the coupling member is defined as a≧b.

In addition, a spacing member 143c is disposed at the coupling member formed at the stator 14 so as to absorb shock during the operation of the motor. [13] The stator core 15 is riveted via a rivet 153 passing thorough a thorough hole formed on the base member 150 so as to be maintained in a stacked structure.

A winding starting portion and a winding ending portion of the stator core 15 are respectively welded to the base member 150.

The bearing housing 7 made of a metal material includes a sill [13] for supporting a front bearing 6a and a rear bearing 6b each mounted on an inner surface thereof so as to prevent each of the bearings from escaping from the bearing housing 7.

Meanwhile, the rotor 13 is coupled with the center of the rear portion of the shaft 4 and the stator 14 is provided inside of the rotor 13 so as to form a direct-driven motor 5, the stator 14 coupled with and fixed on the bearing housing 7 fixed on a side of the tub 2.

In this case, the rotor 13 made of a steel plate material includes an arc formed on a side wall extended from an edge of the bottom surface of the rotor toward the front thereof along the circumference thereof so as to support a magnet (M) mounted in front of the inner surface thereof, and a thorough hole formed in the center of the bottom surface thereof so as to enable a coupling member such as a bolt for coupling the rotor 14 with the shaft 4 to pass therethrough.

In this case, it is desirable that the whole form of the rotor 13 is formed by press working. A plurality of cooling fins are radially formed around the central portion of the rotor 13, the cooling fin performing a function of cooling the heat generated from the stator 14 by blowing air toward the stator 14 during the operation of the rotor 13. In the case, each of the plurality of fins has a predetermined length in a radial direction.

In this case, the cooling fins are bent to face toward an opening member at an angle of 90° to a rear side wall by lancing, and a hole formed by lancing [14] performs a role of a vent.

In addition, an embossing member for reinforcing the strength of the rotor 13 is provided between fins on the rear side wall of the rotor 13, and a drainage hole for draining water is provided on the embossing member.

Meanwhile, a connector 16 is provided in the center of the rotor 13. In this case, the connector 16 includes resin having a different vibration mode from the rotor made of a steel plate material and plays a role of bushing for the rotor. [14]

In the mean time, the stator 14, together with the rotor 13, included in the motor 5 includes a stator core 15 which is a helical core, an insulator 144 for covering the stator core 15, a core 142 wound around a teeth 151 of the stator core 15, and at least three coupling member 143 integrated into the insulator 144 and protruded toward the inside of the core.

As illustrated in FIG. 7, the stator core 15 including the helical core wound up from a bottommost layer to a topmost layer so as to form a multilayered structure. The stator core 15 includes a teeth 151 formed on an outside of the stator core protruded from the base member 150 in a radius direction, and a groove 152 formed at the base member 150 of the stator core 15 so as to reduce stress during the winding of the core. [15]

The stator core 15 is riveted via a rivet 153 passing through the hole formed at the base member 150 so as to be connected. A winding starting portion and a winding ending portion of the stator core 15 are respectively welded to the base member 150.

Meanwhile, the groove 152 formed at the base member 150 of the stator core 15 is formed in a square shape or a trapezoid shape or an arc shape.

As illustrated in FIG. 5, the coupling member 143 of the present invention is formed to be defined as a≧b, when a height of the teeth 151 protruded from the outside of the stator core 15 is “a” and a distance from the inside of the stator core 15 to the center of the coupling hole 143a provided at the coupling member 143 is “b”.

The coupling member 143 is also configured to have a height more than ⅕ of the total height of stacked core. On the other hand, the coupling member 143 may be formed to have a height same as the total height of the stacked core.

In addition, the coupling member 143 includes at least one spacing member 143 for absorbing shock during the operation of the motor, and a position determining projection 143b fitted into a position determining recess formed at the bearing housing 7.

Meanwhile, the position determining projection may be provided at the bearing housing 7 and the position determining recess to which the position determining projection formed at the bearing housing 7 is fitted may be provided at the coupling member 143.

The function of the drum washing machine in accordance with the first embodiment of the present invention structure as mentioned above will be described as follows.

When electric current is sequentially flowed to the core 142 of the stator 14 via a control of a motor driving controller (not shown) attached to a control panel, and the rotator 13 is rotated, the shaft 4 serration coupled with a connector 16 coupled with the rotoe is rotated. Accordingly, electric power is transmitted to the drum 3 thorough the shaft 4, and the drum is rotated.

Meanwhile, the function of the drum washing machine with an operating member of the present invention will be described as follows. First of all, the top loading drum type washing machine of the present invention is light because the tub 2 is made of a plastic material having an excellent heat-resistance, and it is easy to manufacture the washing machine because it is manufactured by injection molding.

In the top loading type washing machine of the present invention, the bearing housing 7 being a bearing supporting means is made of a metal material such as a compound aluminum metal. Since the metal has a strong heat-resistance, the bearing housing 7 can be applicable to a drum washing machine having a drying function.

The stator together with the rotor 13 included in the motor 5 has a structure in which the groove 152 is formed at the base member 150 of the stator core 15 so as to reduce the stress during the winding of the core, the winding is carried out with less power compared to the related art.

The coupling member 143 of the present invention is formed to be defined as a≧b, when a height of the teeth 151 protruded from the outside of the stator core 15 is “a” and a distance from the inside of the stator core 15 to the center of the coupling hole 143a provided at the coupling member 143 is “b”. The formation is determined considering the following problem. Although it is advantageous that torque becomes smaller when the coupling hole 143a is located closer to a point to which weight is applied, it is disadvantageous that many bolts are required to support the whole stator 14 because a diameter of the bolt becomes necessarily small when the coupling member 143a is too close to the point. [17]

The height of coupling member 143 is in the range of 20% to 150% of the height of the whole core because the coupling member 143 may be damaged by vibration generated during the operation of the motor when the height of coupling member 143 is less than 20% of the height of the whole core.

The higher the height of the coupling member 143, the better the stiffness. A total width of the operating member of the washing machine is however increased when the height of the coupling member 143 is too high, resulting in reducing a laundry capacity of the washing machine. Accordingly, the height of coupling member 143 needs to be less than 150% of the height of the whole core.

The spacing member 143c provided at the coupling member 143 performs functions of reducing and decreasing the vibration generated during the operation of the motor, thereby increasing mechanical reliability of the stator 14.

The position determining projection 143b provided at the coupling member is fitted to the position determining recess of the tub 2 so as to help the stator to be easily coupled. In this case, the position determining projection may be provided at the tub 2, and the position determining recess may be provided at the coupling member 143.

The bearing housing 7 in accordance with the present invention includes a sill on a front side of an inner circumferential surface and on a rear side thereof, thereby enabling the support a rear end portion of the front bearing 6a and a front end portion respectively provided on both ends of the shaft 4 on the outer circumferential surface.

In other words, since the bearing housing 7 includes a sill respectively provided on each of the both sides on the inner circumferential surface, the bearings on both sides 6a and 6b are supported and prevented from escaping from the bearing housing 7.

Meanwhile, the rotor 13 included in the direct-driven motor 5 is coupled with the center of the rear end portion of the shaft 4, and the stator 14 is provided inside of the rotor 13. On a side wall vertically extended from an edge of the bottom surface of the rotor 13, an arc having a surface to which a magnet is provided is formed along a circumferential direction so as to support the magnet (M) when the magnet (M) is attached to the inside of the rotor 13. Therefore, it is easy to manufacture the rotor.

A plurality of cooling fins are radially formed on the bottom surface of the rotor 13 and each of the plurality of cooling fins has a predetermine length in a radius direction. Accordingly, air is blown from the cooling fins to the stator 14 during the rotation of the rotor 13, and the heat generated from the stator 14 is cooled.

In this case, the cooling fins are formed to face an opening of the rotor 13 by lancing, and the hole formed by lancing plays a role of a vent. Since the rotor 13 is made of a steel plate material and formed by pressing, the time for manufacturing the rotor is very short, and productivity is increased during the manufacture of the rotor.

In addition, since the bottom surface of the rotor 13 is embossed, the total stiffness of the rotor 13 is increased, and water is discharged through the drainage hole formed on the bottom surface.

Furthermore, the connector 16 made of resin is formed by injection molding and has a vibration mode different from the rotor made of a steel plate so as to play a role of transmitting reduced vibration of the rotor to the shaft 4.

[19] Meanwhile, although not illustrated, contrary to the first embodiment, the tub 2 having a wall member for storing wash water and coupling the operating member is made of a plastic material, and the bearing housing 7 is inserted and molded into the tub 2. Therefore, the stator 14 is directly coupled with a rear wall member of the tub made of the plastic material.

In other words, the bearing housing supports the bearing, and is inserted and molded into the inner side wall of the plastic tub. In this case, a turbo supporter made of a steel material is introduced so as to support the stiffness of a side wall member of the tub.

In this case, the turbo supporter made of the steel material is formed in a steel plate form and has a similar profile as the profile of the side wall of the tub. It is obvious that the stator 14 having the structure applied to the first embodiment is applied in the same way.

Meanwhile, in this case, the tub 2 and the bearing housing 7 are formed as a single body because the bearing housing 7 is inserted into the side wall member of the tub and formed by injection molding, and the process of assembling is simplified because a process of separately assembling the bearing housing 7 to the side wall member of the tub is omitted.

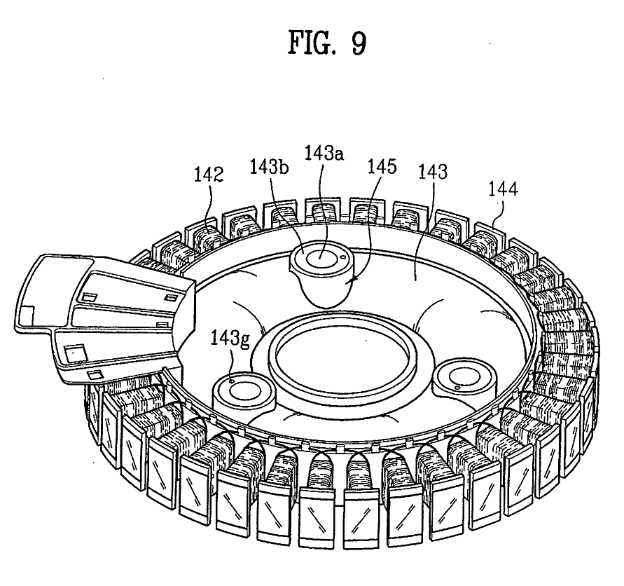

FIG. 9 illustrates a perspective view showing a second embodiment of the stator of the present invention. The stator 14 in accordance with the present embodiment includes a stator core 15 formed in a ring shape and including a multilayered structure in which a plurality of steel plates a teeth 151 and a base member 150 are stacked from a bottommost layer to a topmost layer and spirally rotated, an insulator 144 formed to cover an outside of the stator core 15 via insert molding so as to electrically insulate the stator core 15, and at least three coupling members 143 integrated into the insulator 144 on an inner circumferential surface of the stator core 15 and protruded toward the center of the stator 14.

In addition, a coupling hole 143a is formed in the center of the coupling member 143 so as to fix the stator 14 on the bearing housing 7 attached to a side wall member of the tub 2 via a coupling member such as a screw or a bolt.

Meanwhile, since a surrounding area of the coupling hole 143a is uplifted compared to other portion, the coupling hole is seen to be formed on a cylinder shaped boss 145.

In the mean time, a position determining projection 143b is formed around a coupling hole 620a on a top surface of the cylinder shaped boss 145 so as to reduce an area coupled with a head of a bolt when the bolt is coupled.

A position determining recess 143g is formed at an insulator 144 of the stator 14, a projection corresponding to the recess is formed at the bearing housing 7, and a coupling hole is formed at the bearing housing 7 corresponding to the coupling hole 143a formed at the insulator 144 of the stator 14.

Meanwhile, contrary to the structure, a position determining projection may be formed at the insulator 144 of the stator 14, and a recess corresponding to the position determining projection is formed at the bearing housing.

In this embodiment, a coupling member is also formed to be defined as a≧b, when a height of the teeth 151 protruded from the outside of the stator core 15 is “a” and a distance from the inside of the stator core 15 to the center of the coupling hole 143a provided at the coupling member 143 is “b”. The reason is the same as the foregoing description.

The top loading drum washing machine of the present invention according to each embodiment mentioned above enables to reduce weight and materials needed during the manufacture of the stator 14 including the BLDC motor, to simplify a manufacturing process thereof, and to stably mount the stator 14 at a fixing side such as the bearing housing 7 or the plastic tub 2.

The washing machine of the present invention also provides a structure in which the tub 2 is capable of sustaining the weight and vibration of the motor when the BLDC motor for the washing machine is attached to the bearing housing 7 or directly on a side wall of the tub, the motor having a stator 14 which weighs over 1.5 kg itself and being rotatable at or more than a speed of 0-2,000 RPM and controlling the rotation of the drum 3.

The top loading drum type washing machine in accordance with the present invention enables to easily assemble the stator 14 to the tub side 2 in the process of assemblage, thereby making it easier for a worker to service for maintenance or repair.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

The present invention has effects as follows. First of all, the present invention is capable of reducing the materials and weight needed during the manufacture of a stator of a BLDC motor for a top loading drum type washing machine, and simplifying the manufacturing process, and stably mounting the motor at a fixing side such as a bearing housing or a tub.

The top loading drum type washing machine of the present invention also provides a structure in which a tub is capable of sustaining the weight and the vibration of a motor when the BLDC motor for the washing machine is attached to the bearing housing or directly on a side wall of the tub, the motor having a stator 14 which weighs over 1.5 kg itself and being rotatable at or more than a speed of 0-2,000 RPM and controlling the rotation of the drum 3.

The top loading drum type washing machine in accordance with the present invention enables to easily assemble the stator 14 to the tub side 2 in the process of assemblage, thereby making it easier for a worker to service for maintenance or repair.

The top loading drum type washing machine in accordance with the present invention provides a stator core having a structure in which winding is carried out with ease. Therefore, the basic material is prevented from being wasted, it is easy to manufacture, and stiffness of a coupling member of the stator is the mechanical reliability is increased and life is elongated.

1. A top loading drum type washing machine comprising:
a cabinet having a door at a side thereof;
a tub provided in the cabinet and having a door at a location corresponding to the door of the cabinet;
a drum rotatably supported by left and right sides of the tube and having a door for withdrawing laundries on an outer circumferential surface thereof;
a shaft passed through the tub and pivotly coupled with the drum provided inside of the tub so as to transmit driving force of the motor to the drum;
at least one bearing supporting the shaft;
a bearing housing supporting the bearing and attached to the tub;
a stator weighing over 1.5 kg; and
a rotor covering an outer circumferential surface of the stator;
wherein the stator comprises:
a stator core formed in a ring shape and including a multilayered structure in which a plurality of steel plates including a teeth and a base member are stacked and spirally rotated from a bottommost layer to a topmost layer;
an insulator formed for covering an outside of the stator core via insert molding so as to electrically insulate the stator core; and
at least three coupling members integrated into the insulator on an inner circumferential surface of the stator core, protruded toward the center of the stator and having a coupling hole formed in the center thereof so as to fix the stator on the bearing housing via a screw.

2. The top loading drum type washing machine of claim 1, wherein the tub made of a plastic material and the bearing housing is made of a compound aluminum metal, the bearing housing integrated into the tub via insert molding and having the stator attached thereto.

3. The top loading drum type washing machine of claim 1 further comprising a cylindrical metal inserted into the coupling hole formed in the center of the coupling member.

4. The top loading drum type washing machine of claim 1, wherein height of the coupling member is over 20% of a total height of the stacked core.

5. The top loading drum type washing machine of claim 1, wherein the coupling member is configured to have a height of 20%-150% of a total height of the stacked core.

6. The top loading drum type washing machine of claim 1, wherein the coupling member is formed to be defined as a≧b, when a height of the teeth 151 protruded from the outside of the stator core 15 is “a” and a distance from the inside of the stator core 15 to the center of the coupling hole 143a provided at the coupling member 143 is “b”.

7. The top loading drum type washing machine of claim 1, wherein a spacing member is disposed at the coupling member formed at the stator so as to absorb shock during the operation of the motor.

8. The top loading drum type washing machine of claim 1, wherein the stator core is riveted via a rivet passing thorough a thorough hole formed on the case member so as to be maintained in a stacked structure.

9. The top loading drum type washing machine of claim 1, wherein a winding starting portion and a winding ending portion of the stator core are respectively welded to the base member.

10. The top loading drum type washing machine of claim 1, wherein a position determining projection or a position determining recess is provided at the insulator of the stator, a recess or a projection corresponding to the position determining projection is provided at the bearing housing, and a coupling recess corresponding to the coupling hole provided at the insulator of the stator is provided at the bearing housing.

11. A top loading drum type washing machine comprising:
a cabinet having a door at a side thereof;
a tub provided in the cabinet and having a door at a location corresponding to the door of the cabinet;
a drum rotatably supported by left and right sides of the tube and having a door for withdrawing laundries on an outer circumferential surface thereof;
a shaft passed through the tub and pivotly coupled with the drum provided inside of the tub so as to transmit driving force of the motor to the drum;
at least one bearing supporting the shaft;
a bearing housing supporting the bearing and attached to the tub;
a stator weighing over 1.5 kg; and
a rotor covering an outer circumferential surface of the stator;
wherein the stator comprises:
a stator core formed in a ring shape and including a multilayered structure in which a plurality of steel plates including a teeth and a base member are stacked and spirally rotated from a bottommost layer to a topmost layer;
an insulator for inserting and molding insulating material on an outer surface of the stator core; and
a coupling member integrated into the insulator on an inner circumferential surface of the stator core and protruded toward the center of the stator,
wherein the coupling member comprising:
a coupling hole provided in the center of the coupling member so as to screw down the stator on the bearing housing on a side of the tub;
a position determining projection or position determining recess formed at the insulator of the stator;
a projection or a recess corresponding to the position determining projection and the position determining recess and formed at the bearing housing; and
a coupling hole formed at the bearing housing and corresponding to the coupling hole formed at the insulator of the stator.

12. The top loading drum type washing machine of claim 11, wherein at least three of the coupling members are protruded toward the center of the stator and each spaced from one another.

13. The top loading drum type washing machine of claim 11, wherein a≧b, when a length of the teeth protruded from the outside of the stator core is “a” and a distance from the from the inside of the stator core to the center of the coupling hole provided at the coupling member is “b”.

14. A top loading drum type washing machine comprising:
a cabinet having a door at a side thereof;
a tub made of a plastic material, provided in the cabinet and having a door at a location corresponding to the door of the cabinet;
a drum rotatably supported by left and right sides of the tube and having a door for withdrawing laundries on an outer circumferential surface thereof;
a shaft passed through the tub and pivotly coupled with the drum provided inside of the tub so as to transmit driving force of the motor to the drum;
at least one bearing supporting the shaft;
a bearing housing for supporting the bearing and being inserted and molded into the tub made of the plastic material;
a stator weighing over 1.5 kg; and
a rotor covering an outer circumferential surface of the stator;
wherein the stator comprises:
a stator core formed in a ring shape and including a multilayered structure in which a plurality of steel plates including a teeth and a base member are stacked and spirally rotated from a bottommost layer to a topmost layer;
an insulator inserted and molded into the outside of the stator core; and
a coupling member integrated into the insulator on an inner circumferential surface of the stator core and protruded toward the center of the stator,
wherein the coupling member comprising:
a coupling hole provided in the center of the coupling member so as to screw down the stator on the bearing housing on a side wall member of the tub;
a position determining projection or position determining recess formed at the insulator of the stator;
a projection or a recess corresponding to the position determining projection and the position determining recess and formed on the side wall member of the tub; and
a coupling hole corresponding to the coupling hole formed at the insulator of the stator and formed on the side wall member of the tub.

15. The top loading drum type washing machine of claim 14, wherein a surrounding area of the coupling hole is uplifted compared to other portion.

16. The top loading drum type washing machine of claim 15, wherein a projection is formed around a coupling hole on a top surface of the boss so as to reduce an area coupled with a head of a bolt when the bolt is coupled.

17. A top loading drum type washing machine comprising:
a cabinet having a door at a side thereof;
a tub made of a plastic material, provided in the cabinet and having a door at a location corresponding to the door of the cabinet;
a drum rotatably supported by left and right sides of the tube and having a door for withdrawing laundries on an outer circumferential surface thereof;
a shaft passed through the tub and pivotly coupled with the drum provided inside of the tub so as to transmit driving force of the motor to the drum;
at least one bearing supporting the shaft;
a bearing housing for supporting the at least one bearing and being fixed on the tub;
a stator fixed on a rear side wall member of the tub; and
a rotor covering an outer circumferential surface of the stator;
wherein the stator comprises:
a stator core formed in a ring shape and including a multilayered structure in which a plurality of steel plates including a teeth and a base member are stacked and spirally rotated from a bottommost layer to a topmost layer;
an insulator formed for covering an outside of the stator core via insert molding so as to electrically insulate the stator core; and
a coupling member integrated into the insulator on an inner circumferential surface of the stator core, protruded toward the center of the stator and having a coupling hole formed in the center thereof so as to fix the stator on the bearing housing via a screw.

18. The top loading drum type washing machine of claim 17, wherein the stator weighs over 1.5 kg.

19. The top loading drum type washing machine of claim 17, wherein the bearing housing is made of a compound aluminum metal and integrated into the tub via insert molding, when the tub made of a plastic material is manufactured, and having the stator coupled with the rear side wall member of the tub.

20. The top loading drum type washing machine of claim 17, further comprising a cylindrical metal inserted into the coupling hole provided in the center of the coupling member.

21. The top loading drum type washing machine of claim 17, wherein height of the coupling member is more than 20%-150% of a total height of the stacked cores.

22. The top loading drum type washing machine of claim 17, wherein a≧b, when a length of the teeth protruded from the outside of the stator core is “a” and a distance from the inside of the stator core to the center of the coupling hole 143a provided at the coupling member 143 is “b”.

23. The top loading drum type washing machine of claim 17, wherein a spacing member is disposed at the coupling member formed at the stator so as to absorb shock during the operation of the motor.

24. The top loading drum type washing machine of claim 17, wherein the stator core is riveted via a rivet which passes thorough a thorough hole formed on the base member.

25. The top loading drum type washing machine of claim 17, wherein a winding starting portion and a winding ending portion of the stator core are respectively welded to the base member.

26. The top loading drum type washing machine of claim 17, wherein a position determining projection or a position determining recess is formed at the insulator of the stator, a projection or a recess corresponding to the position determining projection and the position determining recess, and a coupling recess corresponding to the coupling hole is provided at the insulator of the stator is provided at the bearing housing.

27. An outer rotor type DC motor for a top loading drum type washing machine, wherein the top loading drum type washing machine comprises:
a stator core formed in a ring shape and including a multilayered structure in which a plurality of steel plates including a teeth and a base member are stacked and spirally rotated from a bottommost layer to a topmost layer;
an insulator manufactured by inserting the stator core into a mold for forming the insulator and covering with an insulating material so as to insulate the stator core;
a stator integrated into the insulator on an inner circumferential surface of the stator core and including at least three coupling member, the at least three coupling member protruded toward the center of the stator, and coil wound around the teeth of the stator core; and
a rotor provided on an outside of the stator and having a cooling fin and a vent for cooling the stator.

28. An outer rotor type DC motor for a top loading drum type washing machine, wherein the top loading drum type washing machine comprises:
a stator core formed in a ring shape and including a multilayered structure in which a plurality of steel plates including a teeth and a base member are stacked and spirally rotated from a bottommost layer to a topmost layer;
an insulator manufactured by inserting the stator core into a mold for forming the insulator and covering with an insulating material so as to insulate the stator core;
a stator integrated into the insulator on an inner circumferential surface of the stator core and including a coupling member, the coupling member formed in a ring shape and protruded toward the center of the stator, and a coil wound around the teeth of the stator core; and
a rotor provided on an outside of the stator and having a cooling fin and a vent for cooling the stator.
